(19) United States
(12) Patent Application Publication
(10) Pub. No.: US 2026/0250565 A1
(43) Pub. Date: Aug. 27, 2026

(54) METHOD FOR MANUFACTURING BIODEGRADABLE HOT MELT ADHESIVE

(71) Applicant: TEX YEAR INDUSTRIES INC., New Taipei City (TW)

(72) Inventor: YUNG-HAN WU, New Taipei City (TW)

(21) Appl. No.: 19/299,253

(22) Filed: Aug. 13, 2025

(30) Foreign Application Priority Data
Feb. 24, 2025 (TW) 114106767

(51) Int. Cl. C09J 167/04; C09J 11/06; C09J 11/08; C09J 175/08

(52) U.S. Cl. CPC C09J 167/04; C09J 11/06; C09J 11/08; C09J 175/08

(57) ABSTRACT

A method for manufacturing a biodegradable hot melt adhesive includes: mixing multiple biodegradable materials and carrying out a chemical cross-linking reaction to form a copolymer; subjecting the copolymer to a hydrolysis reaction to form a hydrolyzed copolymer; and mixing and heating the hydrolyzed copolymer, a first additive, and a second additive, to form the biodegradable hot melt adhesive. The multiple biodegradable materials include at least two of polylactide acid, polycaprolactone, polybutylene succinate, polyhydroxyalkanoates, and polyethylene glycol. The first additive includes at least one of a tackifying resin and a plasticizer. The second additive includes at least one of an antioxidant and a hydrolysis stabilizer. The method for manufacturing the biodegradable hot melt adhesive has the advantages of a simple production process and a low cost, and the manufactured biodegradable hot melt adhesive has excellent performance.

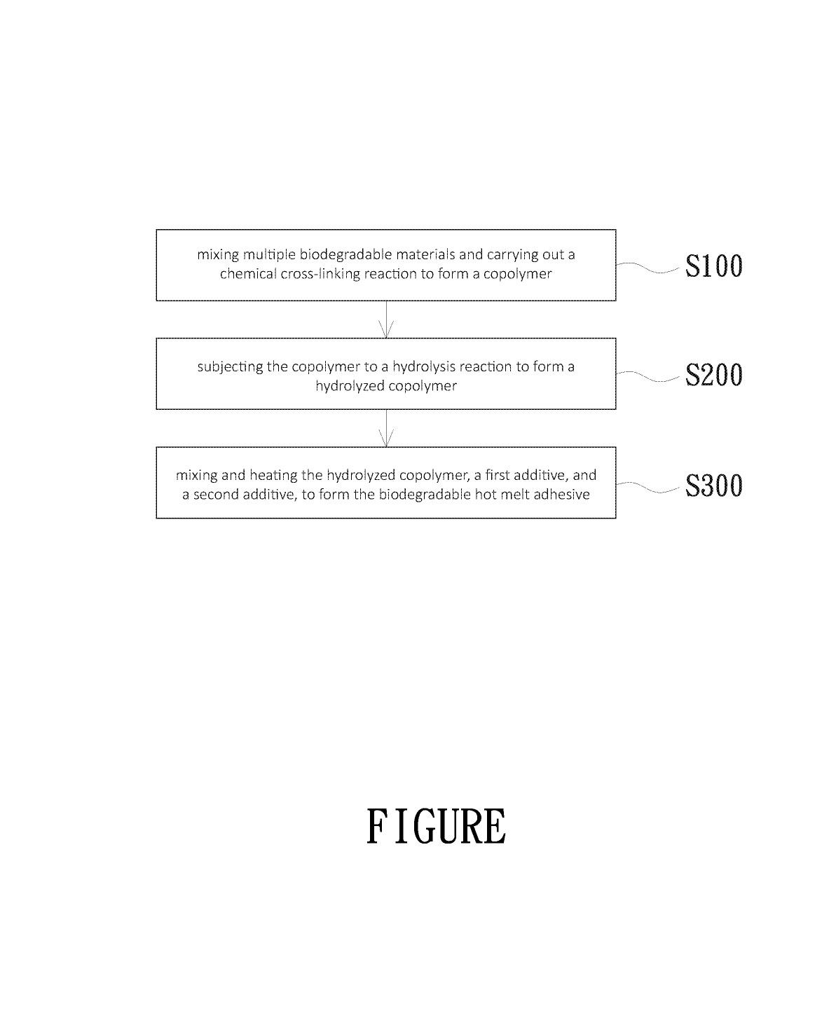

### CROSS-REFERENCE TO RELATED APPLICATION

This application claims the priority benefit of Tawain patent application No. TW114106767, filed on February 24, 2025. The entirety of the above-mentioned patent application is hereby incorporated by reference herein and made a part of this application.

### FIELD OF THE INVENTION

The present disclosure relates to a method for manufacturing a hot melt adhesive, and more particularly to a method for manufacturing a biodegradable hot melt adhesive.

### BACKGROUND OF THE INVENTION

Hot melt adhesive, as an important adhesive, is widely used in various products, such as in packaging, assembly, electronics, and other fields. Traditional hot melt adhesives are primarily made from petrochemical raw materials. Since products made from traditional petrochemical raw materials are typically non-degradable and cause environmental pollution, with the increasing environmental awareness in recent years, relevant industries have introduced hot melt adhesives made from biodegradable materials. Common biodegradable materials include materials such as polylactide acid (PLA) and polyhydroxyalkanoates (PHAs) made from bio-based materials such as starch, cellulose, and vegetable oils, as well as materials such as polycaprolactone (PCL), polybutylene succinate (PBS), and polyethylene glycol (PEG) made from petrochemical-based materials.

However, it is well known that the hot melt adhesives made from the biodegradable materials have poor performance. Additionally, the existing production processes for manufacturing the hot melt adhesives by using the biodegradable materials are very complex. Therefore, how to develop a method for manufacturing a biodegradable hot melt adhesive with a simple production process that can produce the biodegradable hot melt adhesive with excellent performance has become a crucial topic in current technical developments.

### SUMMARY OF THE INVENTION

The present disclosure provides a method for manufacturing a biodegradable hot melt adhesive, which can produce the biodegradable hot melt adhesive with excellent performance and has the advantage of a simple production process.

To achieve one, some, or all of the purposes or other purposes, an embodiment of the present disclosure provides a method for manufacturing a biodegradable hot melt adhesive, including: mixing multiple biodegradable materials and carrying out a chemical cross-linking reaction to form a copolymer; subjecting the copolymer to a hydrolysis reaction to form a hydrolyzed copolymer; and mixing and heating the hydrolyzed copolymer, a first additive, and a second additive, to form the biodegradable hot melt adhesive. The multiple biodegradable materials include at least two of polylactide acid, polycaprolactone, polybutylene succinate, polyhydroxyalkanoates, and polyethylene glycol. The first additive includes at least one of a tackifying resin and a plasticizer. The second additive includes at least one of an antioxidant and a hydrolysis stabilizer.

In an embodiment of the present disclosure, the step of carrying out a chemical cross-linking reaction includes: mixing a cross-linking reaction agent with the multiple biodegradable materials for the chemical cross-linking reaction for 1 to 2 hours under an environment where a temperature ranges from 160 degrees Celsius to 190 degrees Celsius and a pressure ranges from 1 MPa to 1.5 MPa.

In an embodiment of the present disclosure, the cross-linking reaction agent includes at least one of bis(tert-butylperoxyisopropyl)benzene, dicumyl peroxide, stannous isocaprylate, methylene diphenyl diisocyanate, epoxidized soybean oil, maleated soybean oil, and epoxidized soybean oil acrylate; and the cross-linking reaction agent accounts for 0.05 wt% to 3.0 wt% of a total weight of the multiple biodegradable materials and the cross-linking reaction agent.

In an embodiment of the present disclosure, the copolymer has a molecular weight ranging from 500 kDa to 1,500 kDa.

In an embodiment of the present disclosure, the step of subjecting the copolymer to a hydrolysis reaction includes: mixing a hydrolysis reaction agent with the copolymer for the hydrolysis reaction for 1 to 1.5 hours under an environment where a temperature ranges from 130 degrees Celsius to 160 degrees Celsius and a pressure ranges from 1 MPa to 1.5 MPa.

In an embodiment of the present disclosure, the hydrolysis reaction agent includes at least one of sodium hydroxide and potassium hydroxide; and the hydrolysis reaction agent accounts for 0.05 wt% to 3.0 wt% of a total weight of the copolymer and the hydrolysis reaction agent.

In an embodiment of the present disclosure, the hydrolyzed copolymer has a molecular weight ranging from 50 kDa to 300 kDa.

In an embodiment of the present disclosure, the step of mixing and heating the hydrolyzed copolymer, a first additive, and a second additive includes: mixing and stirring the hydrolyzed copolymer, the first additive, and the second additive for 1 to 2 hours under an environment where a temperature ranges from 130 degrees Celsius to 160 degrees Celsius and a pressure ranges from 1 MPa to 1.5 MPa.

In an embodiment of the present disclosure, the first additive accounts for 5 wt% to 50 wt% of the total weight of the hydrolyzed copolymer, the first additive, and the second additive. The second additive accounts for 0.05 wt% to 3.0 wt% of the total weight of the hydrolyzed copolymer, the first additive, and the second additive.

In an embodiment of the present disclosure, the tackifying resin includes at least one of a abietic resin and a terpene resin. The plasticizer includes at least one of triethyl citrate, acetyl triethyl citrate, acetylated tributyl citrate, tributyrin, castor oil, and polyethylene glycol. The hydrolysis stabilizer includes at least one of an epoxy compound and a carbodiimide hydrolysis stabilizer. The antioxidant includes at least one of a hindered phenol antioxidant and a phosphite antioxidant.

According to the present disclosure, the multiple biodegradable materials are mixed and subjected to a chemical cross-linking reaction, which helps enhance the stability of the biodegradable hot melt adhesive; moreover, the molecular weight of the hydrolyzed copolymer is regulated by means of the hydrolysis reaction, facilitating the manufacturing of the biodegradable hot melt adhesive with excellent performance. Additionally, the method for manufacturing a biodegradable hot melt adhesive provided by the present disclosure has the advantage of a simple production process.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The FIGURE is a schematic flow chart of a method for manufacturing a biodegradable hot melt adhesive according to an embodiment of the present disclosure.

### DETAILED DESCRIPTION OF PREFERRED EMBODIMENTS

The FIGURE is a schematic flow chart of a method for manufacturing a biodegradable hot melt adhesive according to an embodiment of the present disclosure. Referring to the FIGURE, a method for manufacturing a biodegradable hot melt adhesive according to an embodiment of the present disclosure includes steps S100 to S300, wherein step S100 involves mixing multiple biodegradable materials and carrying out a chemical cross-linking reaction to form a copolymer. The multiple biodegradable materials include at least two of polylactide acid (PLA), polycaprolactone (PLC), polybutylene succinate (PBS), polyhydroxyalkanoates (PHAs), and polyethylene glycol (PEG). Step S200 involves subjecting the copolymer to a hydrolysis reaction to form a hydrolyzed copolymer. Step S300 involves mixing and heating the hydrolyzed copolymer, a first additive, and a second additive, to form the biodegradable hot melt adhesive, wherein the first additive includes at least one of a tackifying resin and a plasticizer; and the second additive includes at least one of an antioxidant and a hydrolysis stabilizer. According to the method for manufacturing a biodegradable hot melt adhesive according to an embodiment of the present disclosure, by using the biodegradable materials, the problem of environmental pollution caused by non-degradability can be avoided.

According to the method for manufacturing a biodegradable hot melt adhesive according to an embodiment of the present disclosure, by using the multiple biodegradable materials, hot melt adhesives with excellent performance, such as excellent mechanical properties and surface wettability, can be produced. Specifically, different biodegradable materials have different characteristics, for example, from the perspective of mechanical properties, PLA is relatively rigid and brittle, while PCL and PEG are relatively soft and ductile. Therefore, according to the method for manufacturing a biodegradable hot melt adhesive according to an embodiment of the present disclosure, by using the multiple biodegradable materials, the biodegradable hot melt adhesive can have the advantages of each material.

Additionally, according to the method for manufacturing a biodegradable hot melt adhesive according to an embodiment of the present disclosure, through the step of subjecting the multiple biodegradable materials to a chemical cross-linking reaction to form a copolymer, the chemical cross-linking reaction can be made between different biodegradable materials, or it can also be understood as grafting or modifying the biodegradable materials. Therefore, compared with simply physically blending multiple biodegradable materials, subjecting the multiple biodegradable materials to a chemical cross-linking reaction can enhance the compatibility of the multiple biodegradable materials after mixing, thereby improving the thermal stability of the biodegradable hot melt adhesive. In this way, the biodegradable hot melt adhesive can be prevented from phase separation after heating, particularly in scenarios involving extensive continuous use of the hot melt adhesive, heating the hot melt adhesive in an adhesive melting tank, or prolonged heating of the hot melt adhesive. Therefore, the method for manufacturing a biodegradable hot melt adhesive according to an embodiment of the present disclosure facilitates large-scale application of the hot melt adhesive.

According to the method for manufacturing a biodegradable hot melt adhesive according to an embodiment of the present disclosure, the multiple biodegradable materials are mixed and subjected to a sufficient chemical cross-linking reaction, ensuring that the formed copolymer has appropriate uniformity and an appropriate molecular weight. In an embodiment of the present disclosure, the copolymer has a molecular weight, for example, ranging from 500 kDa to 1,500 kDa, preferably ranging from 800 kDa to 1,000 kDa, but which is not specifically limited in the present disclosure and may be adjusted as needed.

In an embodiment of the present disclosure, the step of carrying out a chemical cross-linking reaction in step S100 includes, for example: mixing a cross-linking reaction agent with the multiple biodegradable materials for the chemical cross-linking reaction for 1 to 2 hours under an environment where a temperature ranges from 160 degrees Celsius to 190 degrees Celsius and a pressure ranges from 1 MPa to 1.5 MPa. However, the present disclosure is not limited to this, and it may be adjusted appropriately based on the types and ratios of the selected biodegradable materials. In an embodiment of the present disclosure, the cross-linking reaction agent for the chemical cross-linking reaction includes, for example, at least one of bis(tert-butylperoxyisopropyl)benzene, dicumyl peroxide, stannous isocaprylate, methylene diphenyl diisocyanate, epoxidized soybean oil, maleated soybean oil, and epoxidized soybean oil acrylate. the above-mentioned cross-linking reaction agent accounts for, for example, 0.05 wt% to 3.0 wt%, preferably 0.2 wt% to 1.5 wt%, of a total weight of the multiple biodegradable materials and the cross-linking reaction agent. The present disclosure does not specifically limit thereto, and other types of cross-linking reaction agents may be selected in another embodiment of the present disclosure, or the usage quantity may be adjusted based on the type of the selected cross-linking reaction agent.

Following the above, according to the method for manufacturing a biodegradable hot melt adhesive according to an embodiment of the present disclosure, the molecular weight of the hydrolyzed copolymer can be regulated by means of the hydrolysis reaction, facilitating the manufacturing of the hot melt adhesive with excellent performance such as appropriate fluidity. In an embodiment of the present disclosure, the hydrolyzed copolymer has a molecular weight, for example, ranging from 50 kDa to 300 kDa, preferably ranging from 100 kDa to 150 kDa, but which is not specifically limited in the present disclosure. In another embodiment of the present disclosure, the molecular weight of the hydrolyzed copolymer may be determined based on desired hot melt adhesive performance or the types and quantities of the first additive and the second additive used in step S300. In an embodiment of the present disclosure, the smaller the molecular weight of the hydrolyzed copolymer, the higher the fluidity of the manufactured hot melt adhesive, for example. It is worth mentioning that when the hydrolyzed copolymer has a molecular weight of 100 kDa or more, it has a stronger cohesion, which helps prevent poor performance of the hot melt adhesive due to excessive degradation after heating.

In an embodiment of the present disclosure, the step of subjecting the copolymer to a hydrolysis reaction in step S200 includes, for example: mixing a hydrolysis reaction agent with the copolymer for the hydrolysis reaction for 1 to 1.5 hours under an environment where a temperature ranges from 130 degrees Celsius to 160 degrees Celsius and a pressure ranges from 1 MPa to 1.5 MPa. However, the present disclosure is not limited thereto, and it may be adjusted appropriately based on the types of the selected biodegradable materials and the molecular weight of the selected copolymer. In an embodiment of the present disclosure, the hydrolysis reaction agent for the hydrolysis reaction includes, for example, at least one of inorganic bases such as sodium hydroxide and potassium hydroxide. The above-mentioned hydrolysis reaction agent accounts for, for example, 0.05 wt% to 3.0 wt%, preferably 0.2 wt% to 1.5 wt%, of a total weight of the copolymer and the hydrolysis reaction agent. The present disclosure does not specifically limit thereto, and other types of hydrolysis reaction agents may be selected in another embodiment of the present disclosure, or the usage quantity may be adjusted based on the type of the selected hydrolysis reaction agent.

Next, according to the method for manufacturing a biodegradable hot melt adhesive according to an embodiment of the present disclosure, the hot melt adhesive is prepared by using the hydrolyzed copolymer, and the appropriate additives are used, such that the biodegradable hot melt adhesive with excellent performance such as appropriate fluidity, wettability, and molecular weight can be obtained. Specifically, in an embodiment of the present disclosure, the step of mixing and heating the hydrolyzed copolymer, a first additive, and a second additive in step S300 includes, for example: mixing and stirring the hydrolyzed copolymer, the first additive, and the second additive for 1 to 2 hours under an environment where a temperature ranges from 130 degrees Celsius to 160 degrees Celsius and a pressure ranges from 1 MPa to 1.5 MPa. However, the present disclosure is not limited thereto, and it may be adjusted appropriately based on the types of the selected biodegradable materials and the molecular weight of the selected hydrolyzed copolymer.

It is worth noting that according to the method for manufacturing a biodegradable hot melt adhesive according to an embodiment of the present disclosure, the polymers (e.g., PLA, and PCL) are directly used as materials, which is beneficial to the production of the biodegradable hot melt adhesive. Specifically, according to the method for manufacturing a biodegradable hot melt adhesive according to an embodiment of the present disclosure, the polymers (e.g., PLA) are directly used as materials, it may not involve the step of polymerizing monomers into a polymer (e.g., the step of polymerizing monomers of PLA into PLA). Furthermore, the step of polymerizing monomers into a polymer requires stringent reaction conditions, and it can also be understood that it requires relatively strict reactant compositions. Therefore, according to the method for manufacturing a biodegradable hot melt adhesive according to an embodiment of the present disclosure, it does not involve the step of polymerizing monomers into a polymer, so the biodegradable hot melt adhesive can be continuously produced by using a single reaction kettle.

Compared with this, in the existing methods for manufacturing a biodegradable hot melt adhesive, monomers are used as materials, and the production processes involve the step of polymerizing monomers into a polymer, so the existing manufacturing methods face the following problems: if a single reaction kettle is used, thorough cleaning of the reaction kettle is required before manufacturing the next batches of biodegradable hot melt adhesives, so as to prevent the next batches of monomers from contamination by residual manufactured biodegradable hot melt adhesives from previous batches in the reaction kettle; alternatively, multiple reaction kettles have to be used for separate monomer polymerization reaction and blending reaction. On such basis, according to the method for manufacturing a biodegradable hot melt adhesive according to an embodiment of the present disclosure, the biodegradable hot melt adhesive can be manufactured in a single reaction kettle, so it has the following advantages: 1. the time spent on the replacement of a reaction kettle is saved; 2. the material loss caused by the replacement of a reaction kettle is reduced; and 3. energy consumption is reduced. In short, the method for manufacturing a biodegradable hot melt adhesive provided by the present disclosure has the advantage of a simple production process.

In an embodiment of the present disclosure, the use of the first additive and the second additive in step S300 enables the biodegradable hot melt adhesive to have appropriate properties. In an embodiment of the present disclosure, the first additive accounts for, for example, 5 wt% to 50 wt% of a total weight of the hydrolyzed copolymer, the first additive, and the second additive; and the second additive accounts for, for example, 0.05 wt% to 3.0 wt% of the total weight of the hydrolyzed copolymer, the first additive, and the second additive. However, the present disclosure does not limit thereto, and the usage amount may be adjusted as needed.

In an embodiment of the present disclosure, the tackifying resin includes, for example, at least one of a abietic resin and a terpene resin. The plasticizer includes, for example, at least one of triethyl citrate, acetyl triethyl citrate, acetylated tributyl citrate, tributyrin, castor oil, and polyethylene glycol. The hydrolysis stabilizer includes, for example, at least one of an epoxy compound and a carbodiimide hydrolysis stabilizer. The antioxidant includes, for example, at least one of a hindered phenol antioxidant and a phosphite antioxidant.

It needs to be noted that the present disclosure does not limit the types and usage quantity of the first additive and the second additive. In another embodiment of the present disclosure, other types of additives may be selected as needed, or the usage quantity may be adjusted based on the types of the selected additives.

### Embodiment 1

Step S100: two biodegradable materials (79.7 wt% polylactide acid and 20 wt% polycaprolactone) were mixed with 0.3 wt% bis(tert-butylperoxyisopropyl)benzene, and the mixture was placed into a reaction kettle. A chemical cross-linking reaction was carried out for 2 hours under an environment where a temperature was 180 degrees Celsius and a pressure was 1.5 MPa, to form a copolymer with a molecular weight of 980 kDa. The polylactide acid has a molecular weight of, for example, 700 kDa, and the polycaprolactone has a molecular weight of, for example, 60 kDa.

Step S200: the copolymer and a hydrolysis reaction agent were subjected to a hydrolysis reaction for 1 hour, for example, under an environment where a temperature was 150 degrees Celsius and a pressure was 1.5 MPa, to form a hydrolyzed copolymer with a molecular weight of 140 kDa. The copolymer accounts for, for example, 99.5 wt% of the total weight of the copolymer and the hydrolysis reaction agent, but the present disclosure is not limited thereto. The hydrolysis reaction agent is, for example, sodium hydroxide. The hydrolysis reaction agent accounts for, for example, 0.5 wt% of the total weight of the copolymer and the hydrolysis reaction agent. However, the present disclosure does not specifically limit thereto, and the usage quantity of the hydrolysis reaction agent may be increased or decreased as appropriate. For example, the pH value of the mixture after mixing the hydrolysis reaction agent with the copolymer is allowed to fall within 8 to 10, thereby controlling the rate of the hydrolysis reaction. In an embodiment of the present disclosure, the higher the pH value, the higher the rate of the hydrolysis reaction, for example.

Step S300: the hydrolyzed copolymer, a abietic resin, tributyrin, a carbodiimide hydrolysis stabilizer, and a hindered phenol antioxidant were mixed. Mixing and stirring were carried out for 1 hour under an environment where a temperature was 150 degrees Celsius and a pressure was 1 MPa, to form a biodegradable hot melt adhesive with a viscosity of 1,000 to 30,000 cps at 140 degrees Celsius to 180 degrees Celsius. The hydrolyzed copolymer accounts for, for example, 80.5 wt% of the total weight of the hydrolyzed copolymer, the first additive, and the second additive. The abietic resin accounts for, for example, 10 wt% of the total weight of the hydrolyzed copolymer, the first additive, and the second additive. The tributyrin accounts for, for example, 8 wt% of the total weight of the hydrolyzed copolymer, the first additive, and the second additive. The carbodiimide hydrolysis stabilizer and the hindered phenol antioxidant account for, for example, 1.5 wt% of the total weight of the hydrolyzed copolymer, the first additive, and the second additive.

### Embodiment 2

Step S100: three biodegradable materials (58.8 wt% polylactide acid, 25 wt% polyhydroxyalkanoates, and 15 wt% polyethylene glycol) were mixed with 1.2 wt% methylene diphenyl diisocyanate, and the mixture was placed into a reaction kettle. A chemical cross-linking reaction was carried out for 2 hours under an environment where a temperature was 170 degrees Celsius and a pressure was 1.5 MPa, to form a copolymer with a molecular weight of 820 kDa. The polylactide acid has a molecular weight of, for example, 700 kDa, the polyhydroxyalkanoates have a molecular weight of, for example, 80 kDa, and the polyethylene glycol has a molecular weight of, for example, 2 kDa.

Step S200: the copolymer and a hydrolysis reaction agent were subjected to a hydrolysis reaction for 1 hour, for example, under an environment where a temperature was 160 degrees Celsius and a pressure was 1.5 MPa, to form a hydrolyzed copolymer with a molecular weight of 120 kDa. The copolymer accounts for, for example, 99.5 wt% of the total weight of the copolymer and the hydrolysis reaction agent, but the present disclosure is not limited thereto. The hydrolysis reaction agent is, for example, sodium hydroxide. The hydrolysis reaction agent accounts for, for example, 0.5 wt% of the total weight of the copolymer and the hydrolysis reaction agent. However, the present disclosure does not specifically limit thereto, and the usage quantity of the hydrolysis reaction agent may be increased or decreased as appropriate, and for example, the pH value of the mixture after mixing the hydrolysis reaction agent with the copolymer is allowed to fall within 8 to 10.

Step S300: the hydrolyzed copolymer, a hydrogenated abietic ester, acetyl triethyl citrate, a carbodiimide hydrolysis stabilizer, and a hindered phenol antioxidant were mixed. Mixing and stirring were carried out for 1 hour, for example, under an environment where a temperature was 150 degrees Celsius and a pressure was 1 MPa, to form a biodegradable hot melt adhesive with a viscosity of 1,000 to 30,000 cps at 140 degrees Celsius to 180 degrees Celsius. The hydrolyzed copolymer accounts for, for example, 65.0 wt% of the total weight of the hydrolyzed copolymer, the first additive, and the second additive. The hydrogenated abietic ester accounts for, for example, 20.0 wt% of the total weight of the hydrolyzed copolymer, the first additive, and the second additive. The acetyl triethyl citrate accounts for, for example, 13.0 wt% of the total weight of the hydrolyzed copolymer, the first additive, and the second additive. The carbodiimide hydrolysis stabilizer and the hindered phenol antioxidant account for, for example, 2.0 wt% of the total weight of the hydrolyzed copolymer, the first additive, and the second additive.

In summary, according to the present disclosure, the multiple biodegradable materials are mixed and subjected to a chemical cross-linking reaction, which helps enhance the thermal stability of the biodegradable hot melt adhesive; moreover, the molecular weight of the hydrolyzed copolymer can be regulated by means of the hydrolysis reaction, facilitating the manufacturing of the biodegradable hot melt adhesive with excellent performance. Additionally, the method for manufacturing a biodegradable hot melt adhesive provided by the present disclosure has the advantage of a simple production process.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing a biodegradable hot melt adhesive, comprising:
mixing multiple biodegradable materials and carrying out a chemical cross-linking reaction to form a copolymer;
subjecting the copolymer to a hydrolysis reaction to form a hydrolyzed copolymer; and
mixing and heating the hydrolyzed copolymer, a first additive, and a second additive, to form the biodegradable hot melt adhesive,
wherein the biodegradable materials comprise at least two of polylactide acid, polycaprolactone, polybutylene succinate, polyhydroxyalkanoates, and polyethylene glycol; the first additive comprises at least one of a tackifying resin and a plasticizer; and the second additive comprises at least one of an antioxidant and a hydrolysis stabilizer.

2. The method for manufacturing a biodegradable hot melt adhesive according to claim 1, wherein the step of carrying out the chemical cross-linking reaction comprises:
mixing a cross-linking reaction agent with the biodegradable materials for the chemical cross-linking reaction for 1 to 2 hours under an environment where a temperature ranges from 160 degrees Celsius to 190 degrees Celsius and a pressure ranges from 1 MPa to 1.5 MPa.

3. The method for manufacturing a biodegradable hot melt adhesive according to claim 2, wherein the cross-linking reaction agent comprises at least one of bis(tert-butylperoxyisopropyl)benzene, dicumyl peroxide, stannous isocaprylate, methylene diphenyl diisocyanate, epoxidized soybean oil, maleated soybean oil, and epoxidized soybean oil acrylate; and the cross-linking reaction agent accounts for 0.05 wt% to 3.0 wt% of a total weight of the biodegradable materials and the cross-linking reaction agent.

4. The method for manufacturing a biodegradable hot melt adhesive according to claim 1, wherein the copolymer has a molecular weight ranging from 500 kDa to 1,500 kDa.

5. The method for manufacturing a biodegradable hot melt adhesive according to claim 1, wherein the step of subjecting the copolymer to the hydrolysis reaction comprises:
mixing a hydrolysis reaction agent with the copolymer for the hydrolysis reaction for 1 to 1.5 hours under an environment where a temperature ranges from 130 degrees Celsius to 160 degrees Celsius and a pressure ranges from 1 MPa to 1.5 MPa.

6. The method for manufacturing a biodegradable hot melt adhesive according to claim 5, wherein the hydrolysis reaction agent comprises at least one of sodium hydroxide and potassium hydroxide; and the hydrolysis reaction agent accounts for 0.05 wt% to 3.0 wt% of a total weight of the copolymer and the hydrolysis reaction agent.

7. The method for manufacturing a biodegradable hot melt adhesive according to claim 1, wherein the hydrolyzed copolymer has a molecular weight ranging from 50 kDa to 300 kDa.

8. The method for manufacturing a biodegradable hot melt adhesive according to claim 1, wherein the step of mixing and heating the hydrolyzed copolymer, the first additive, and the second additive comprises:
mixing and stirring the hydrolyzed copolymer, the first additive, and the second additive for 1 to 2 hours under an environment where a temperature ranges from 130 degrees Celsius to 160 degrees Celsius and a pressure ranges from 1 MPa to 1.5 MPa.

9. The method for manufacturing a biodegradable hot melt adhesive according to claim 1, wherein the first additive accounts for 5 wt% to 50 wt% of a total weight of the hydrolyzed copolymer, the first additive, and the second additive; and the second additive accounts for 0.05 wt% to 3.0 wt% of the total weight of the hydrolyzed copolymer, the first additive, and the second additive.

10. The method for manufacturing a biodegradable hot melt adhesive according to claim 1, wherein the tackifying resin comprises at least one of a abietic resin and a terpene resin; the plasticizer comprises at least one of triethyl citrate, acetyl triethyl citrate, acetylated tributyl citrate, tributyrin, castor oil, and polyethylene glycol; the hydrolysis stabilizer comprises at least one of an epoxy compound and a carbodiimide hydrolysis stabilizer; and the antioxidant comprises at least one of a hindered phenol antioxidant and a phosphite antioxidant.
